(19) United States
(12) Patent Application Publication
(10) Pub. No.: US 2020/0167057 A1
(43) Pub. Date: May 28, 2020

(54) Automatically Generated Cursor Bitmap Files from Scalable Vector Graphic (SVG) Files

(71) Applicant: Microsoft Technology Licensing, LLC, Redmond, WA (US)

(72) Inventors: Jason Anthony GRIEVES, Bellevue, WA (US); Zhengyang CONG, Seattle, WA (US); David Alan FERGUSON, Woodinville, WA (US); Arthur LATACHE PIMENTEL GESTEIRA COSTA, Jaboatao dos Guararapes (BR)

(73) Assignee: Microsoft Technology Licensing, LLC, Redmond, WA (US)

(21) Appl. No.: 16/202,761

(22) Filed: Nov. 28, 2018

(51) Int. Cl. G06F 3/0481; G06F 3/0484

(52) U.S. Cl. CPC G06F 3/04812; G06F 2203/04801; G06F 3/04845

(57) ABSTRACT

Described herein is a system for automatically generating a cursor bitmap file for a particular cursor in order to assist computer user(s) with low vision to navigate computer display(s). User input to modify a particular cursor (e.g., color, and/or size) to be displayed on a computer display can be received. A base scalable vector graphic (SVG) file representation associated with the particular cursor can be modified in accordance with the user input. The modified base SVG file representation can be converted to a bitmap file representation of the modified base SVG file representation. The bitmap file representation of the modified base SVG file representation can be stored for use in displaying the particular cursor.

### BACKGROUND

Many conventional cursor(s) (e.g. the mouse cursor) are generally defined by a bitmap of a computer display. Computer user(s) with low vision can have a difficult time navigating the computer display utilizing conventional cursor(s). Depending upon vision abilities of a particular user, the size, shape, color, etc. of the cursor(s) may be difficult for the particular user to view and/or interact with.

### SUMMARY

Described herein is a system for automatically generating a cursor bitmap file for a particular cursor, comprising: a processing system comprising one or more processors and a memory having computer-executable instructions stored thereupon which, when executed by the one or more processors, cause the processing system to: receive user input to modify a particular cursor to be displayed on a computer display; modify a base scalable vector graphic (SVG) file representation associated with the particular cursor in accordance with the user input; convert the modified base SVG file representation to a bitmap file representation of the modified base SVG file representation; and store the bitmap file representation of the modified base SVG file representation for use in displaying the particular cursor.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for automatically generating a cursor bitmap file from a scalable vector graphic file.

FIG. 2 is a diagram of an exemplary user interface.

FIG. 3 is a flow chart of a method of automatically generating a cursor bitmap file from a scalable vector graphic file.

FIG. 4 is a flow chart of another method of automatically generating a cursor bitmap file from a scalable vector graphic file.

FIG. 5 is a functional block diagram that illustrates an exemplary computing system.

### DETAILED DESCRIPTION

Various technologies pertaining to automatically generating cursor bitmap file(s) from scalable vector graphic (SVG) file(s) are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding automatically generating cursor bitmap file(s) from scalable vector graphic (SVG) file(s). What follows are one or more exemplary systems and methods.

Aspects of the subject disclosure pertain to the technical problem of automatically generating cursor bitmap file(s) from scalable vector graphic (SVG) file(s) in order to assist computer user(s) with low vision to navigate computer display(s). The technical features associated with addressing this problem involve receiving user input to modify a particular cursor (e.g., color, and/or size) to be displayed on a computer display. A base scalable vector graphic (SVG) file representation associated with the particular cursor (e.g., system cursor(s)) is modified in accordance with the user input. The modified base SVG file representation is converted to a bitmap file representation of the modified base SVG file representation. The bitmap file representation of the modified base SVG file representation is stored for use in displaying the particular cursor. Accordingly, aspects of these technical features exhibit technical effects of more efficiently and effectively modifying computer cursor(s), for example, reducing computer resources such as memory and/or storage required to generate cursor(s) to assist computer user(s) with low vision to navigate computer display(s). For example, in some scenarios, traditional bitmap-based cursors for a particular operating system require every bitmap to be stored locally, thus requiring significant computer storage (e.g., memory). The system and method described herein can allow bitmap(s) to be generated dynamically in response to user input thus reducing consumption of computer storage.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

As discussed above, computer user(s) with low vision can have a difficult time navigating a computer display with conventional (e.g., default) cursor(s). Depending upon vision abilities of a particular user, the size, shape, color, etc. of the default cursor(s) may be difficult for the particular user to view and/or interact with. Historically, individual special cursor(s) have been created manually. However, for computing systems having a plurality of system cursors (e.g., 16 system cursors) for a plurality of resolutions (e.g., 5 display resolutions), storage of these system cursor variations for different sizes and colors is not practical.

Described herein is a system and method for automatically generating cursor bitmap file(s) from scalable vector graphic (SVG) file(s). A user can provide input selecting, for example, cursor size, and/or color. A two-dimensional base SVG document representation (e.g., local copy of previously stored file) can be modified based upon the size, and/or color selected by the user. A bitmap file representation of the modified SVG document representation can then be generated and stored. The bitmap file representation of the modified SVG document representation can then be used to overwrite an existing cursor file (e.g., bitmap of a particular system cursor).

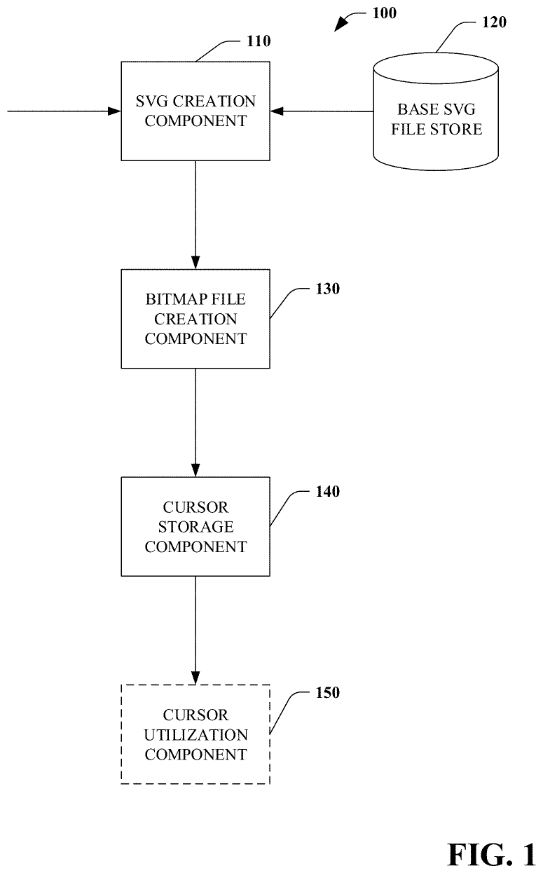

Referring to FIG. 1, a system for automatically generating a cursor bitmap file from a scalable vector graphic file 100 is illustrated. The system 100 can modify a base SVG file representation in accordance with user input (e.g., color and/or size of cursor), for example, to assist user(s) with low vision to better navigate a computer display. A bitmap file representation of the modified SVG file representation can then be generated, stored, and utilized, for example, in place of an existing system cursor file.

SVG is a computer graphics image format built as Extensible Markup Language (XML) objects according to the W3C SVG standard developed by the World Wide Web Consortium (W3C). As vector graphics, SVGs are composed of a fixed set of shapes that can be adjusted as the size of the SVG is adjusted and/or the color of the shapes are modified. Scaling of an SVG image can preserve an underlying shape, that is, since SVGs rely on vectors and shapes instead of bitmaps, resizing is generally performed without blurring.

The system 100 includes an SVG creation component 110 that creates SVG file(s) for the cursor in accordance with received user input and stored base SVG file(s) received from a base SVG file store 120. In some embodiments, the user input can be received via one or more graphical user interface(s). In some embodiments, the user input can be received via an electronic file.

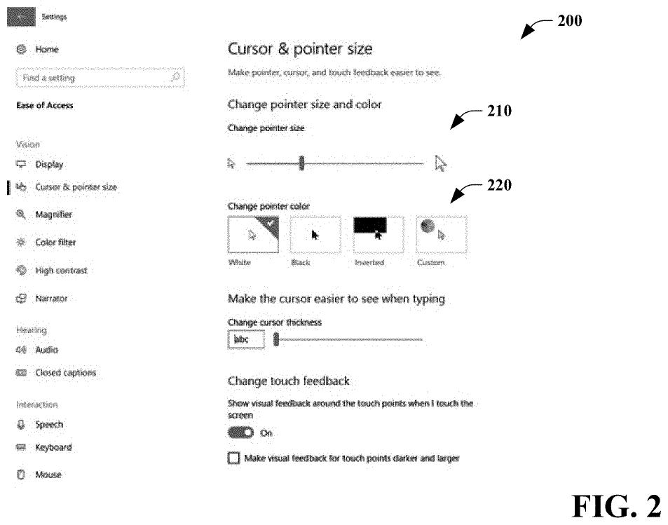

One or more stored base SVG file representation(s) (e.g., local copy of stored base SVG file(s)) can be modified based upon user input regarding size, and/or color desired by the user. Referring briefly to FIG. 2, for purposes of explanation and not limitation, an exemplary user interface 200 for cursor customization is illustrated. In some embodiments, the user interface 200 can be a component of an ease of access user experience which assists user(s) with low vision to modify setting(s) of the user's computer in order to allow the user to more effectively interact with the user's computer.

Through the user interface 200, the user can interact with a size control 210 to change a size of the cursor (e.g., pointer). For purposes of explanation and not limitation, the size control 210 is depicted as a slider having tick marks marking the different values accepted (e.g., distinct sizes at 1×, 2×, 3×, and 4×).

The user can also interact with a color control 220 to change a color of the cursor. For purposes of explanation and not limitation, the color control 220 can be depicted as including a palette of colors and an option to specify a custom color.

Turning back to FIG. 1, each stored base SVG file can describe how a particular cursor is drawn (e.g., base shape of the particular cursor). In some embodiments, the base SVG file store 120 includes base SVG files for one or more system cursors: arrow, I-beam, hourglass, crosshair, vertical arrow, double-pointed arrow pointing northwest and southeast, double-pointed arrow pointing northeast and southwest, double-pointed arrow pointing west and east, double-pointed arrow pointing north and south, four-pointed arrow pointing north, south, east, and west, slashed circle, standard arrow and small hourglass, arrow and question mark, hand, PIN, and/or person. In some embodiments, the base SVG file store 120 includes base SVG file(s) for one or more application cursor(s).

For purposes of explanation and not limitation, Table 1 includes XML code of an exemplary stored base SVG file (e.g., cursor):

TABLE 1

```
<? xml version=“1.0” encoding=“utf-8”?>
<svg version=“1.1” id=“Layer_1”
  xmlns=“http://www.w3.org/2000/svg”
  xmlns:xlink=“http://www.w3.org/1999/xlink”
  x=“0px” y=“0px” style=“enable-background:new 0
  0 128 128;” xml:space=“preserve”>
<title>cursors</title>
<polygon style=“fill: #FFFF00; stroke: #000000”
  points=“13.9,39.85 23.75,59.65 28,57.6
  18.45,38.45 37.1,38.45 1,2.4 2,52.75 ”>
<path style=“stroke: #000000; fill: #000000;”
  d=“M23.3,61L13.6,41.55L0,55.15V0l39.5,
  39.45H20.05l9.3,18.55L23.3,61z
  M13.6,39.85l9.4,19.8l4.25-
  2.1L18.45,38.45h18.65L1,2.4v50.35
  L13.9,39.85z”/>
</svg>
```

Once user input has been received regarding size, and/or color desired by the user, the SVG creation component 110 can create modified version(s) (e.g., locally stored representation(s)) of one or more stored base SVG file representation(s). In some embodiments, the SVG creation component 110 creates modified version(s) (e.g., local representation(s)) of a plurality of stored base SVG file representations, with each file associated with a particular system cursor.

In some embodiments, the SVG creation component 110 modifies the base SVG file representation(s) in accordance with the size input received from the user. In some embodiments, the SVG creation component 110 modifies the base SVG file representation(s) in accordance with color input received from the user.

With respect to recoloring the base SVG file representation(s), in some embodiments, when a high contract theme has been selected, the color(s) of the cursor does not change automatically. That is, if a user changes the color to “yellow” in the custom colors selection, when in a high contrast theme, the cursor remains “yellow”. In some embodiments, when in a color file mode, the cursor(s) do not change.

In some embodiments, the custom color selection of the user is used for the inside of the polygon defined by a particular base SVG file representation. However, when a black or color value with lightness from hue, saturation, lightness (HSL) is less than a threshold amount (e.g., 40%), the outline of the polygon defined by the particular base SVG file representation is changed, for example, to white. In some embodiments, the outline of the polygon is always to a particular color (e.g., black). In some embodiments, the outline of the polygon is selected by a user. In some embodiments, the user color selection is applied to one or more system cursor(s) (e.g., static cursor(s)) while an existing color selection is retained for other system cursor(s) (e.g., animated system cursor(s))

A bitmap file creation component 130 converts the modified base SVG file representation to a bitmap file representation of the modified base SVG file representation. In some embodiments, the bitmap file creation component 130 can generate an image in a specific buffer in accordance with instructions specified in the modified base SVG file representation. The bitmap file creation component 130 can then read pixel values associated with the generated image in the buffer to generate the bitmap file representation of the modified base SVG file representation.

In addition to the bitmap file representation of the modified base SVG file representation, the bitmap file creation component 130 can modify a cursor file header, a cursor directory entry, and/or a bitmap header. For purposes of explanation and not limitation, a particular operating system can employ a particular quantity (e.g., five) of bitmap sizes for each display density. Bitmap files associated with particular cursors can be stored in a particular location and include a header and a plurality of bitmaps with each bitmap corresponding to a display density mapping.

An exemplary cursor file header is:

TABLE 2

```
short reserved; // always set to 0
short icoType; // serves to identify if it is an ICO or a
  CUR; cur files are set to 2
short numberOfBitmaps; // states how many bitmaps are
  in this cur file; for example, 5
```

An exemplary cursor directory entry cursor directory entry header is:

TABLE 3

```
unsigned char width; // represents bitmap width, usually
  overridden by the bitmap header
unsigned char height; // represents bitmap height,
  usually overridden by the bitmap header
unsigned char colorsInPalette; // number of colors used
  in the bitmap palette, if any
unsigned char reserved; // always 0
short hotspotX, hostpotY // The input point of the
  mouse, relative to the bitmap pixels
unsigned long size; // size in bytes of the bitmap
unsigned long offset; // offset of the bitmap from the
  start of the cur file
```

The “hot spot” is a pixel that marks an exact screen location that is affected by a mouse event such as a clicking a mouse button.

In some embodiments, the bitmap doesn't have a fixed position and can be located anywhere after the cursor directory entry. The bitmaps can be composed of four items: a header, a color palette, an XOR map and an AND map. An exemplary bitmap header is:

```
unsigned long headerSize; // states the header size,
  always 40
long width; // width of the bitmap
long height; // height of the bitmap (2× the size of the
  bitmap due to the and map)
short colorPlanes; // number of color planes, always set
  to 1 in cur files
short bitsPerPixel; // how many bits per pixel
long compression; // defines which compression is
  being utilized, 0 if none
long imageSize; // size in bytes of the bitmap
long horizontalResolution;
long verticalResolution; // the resolution indicated how
  many pixels per meter should be; 0 for cur files
long paletteSize; // the size of the color palette, 0 if not
  being used
long importantColors; // number of important colors in
  the palette, 0 if all colors are important
```

To compress bitmaps a color palette can be added. The color palette comprises a table with the colors in a list format, so when the colors are referenced in the image, it is a position in the color table. Each color has four bytes one for each color, and one zero for padding.

With respect to the XOR map, for each pixel, information is provided regarding the color. If the bitmap uses a color palette, each pixel will be represented by a position in the color palette, otherwise it is information about the color itself. In some embodiments, each four bytes represent a pixel. The four bytes represent alpha, red, green and blue. The formula used to calculate the color of each pixel is: (backgroundpixel AND andmap) XOR xormap, to create an inverted cursor. In some embodiments, the XOR map can be used for transparency.

The AND map can comprise one bit per pixel, padded with zeros in a way that each line has a multiple of four bytes. The AND map can be used to create inverted color, otherwise it can be set to zeros if there is an alpha channel in the bitmap that handles transparency.

In some embodiments, inverted cursors are special in that they cannot be represented by 32-bit pixels and are identified by an all-white pixel (RGB=FFFFFF) and an alpha channel equivalent of 00. As a result, resizing the inverted cursor(s) involves a special case where the bits per pixel is 16. This allows for retention of the alpha channel value for inversion. Thus, the system 100 can check for the inverted case and replace each of the inside colors with inverted value(s) for the XOR and AND maps.

In some embodiments, file(s) for animated cursor(s) include several cursors, and the duration of each frame. For example, they can be Resource Interchange File Format (RIFF) which are composed by chunks, with four bytes identifying the type of the chunk. For purposes of explanation and not limitation, a simple RIFF that represents an animated cursor can be represented by the following structure:

TABLE 4
struct_RiffAniFile
{

| | |
|---|---|
| DWORD FileId; | /* File ID (always “RIFF”) */ |
| DWORD Size; | /* Length of file minus 8 in |
| | bytes */ |

| | |
|---|---|
| DWORD FormID; | /* Format ID (always |
| | “ACON”) */ |

| | |
|---|---|
| ANIHEADERSUBCHUNK AniHeader; | /* Header |

subchunk */

| | |
|---|---|
| LISTFRAMECHUNK ListFrame; | /* LIST Frame |
| | chunk */ |

} RIFFANIFILE;

The header:

TABLE 5
struct_AniHeaderSubchunk
{

| | |
|---|---|
| DWORD ChunkId; | /* Subchunk ID (always |
| | “anih”) */ |

| | |
|---|---|
| DWORD Size; | /* Length of subchunk minus 8 */ |

| | |
|---|---|
| DWORD HeaderSize; | /* Size of the subchunk data |

in bytes */

| | |
|---|---|
| DWORD NumFrames; | /* Number of icon or cursor |

frames */

| | |
|---|---|
| DWORD NumSteps; | /* Number of steps in the |

animation */

| | |
|---|---|
| DWORD Width; | /* Width of frame in pixels */ |
| DWORD Height; | /* Height of frame in pixels */ |

| | |
|---|---|
| DWORD BitCount; | /* Number of bits in the frame |

pixels */

| | |
|---|---|
| DWORD NumPlanes; | /* Number of color planes in |

the frame data */

| | |
|---|---|
| DWORD DisplayRate; | /* Default frame display |

rate */

| | |
|---|---|
| DWORD Flags; | /* File attributes flags */ |

} ANIHEADERSUBCHUNK;

The list:

TABLE 6
typedef struct_ListFrameChunk
{

| | | |
|---|---|---|
| DWORD | ListId; | /* “LIST” */ |

| | | |
|---|---|---|
| DWORD | ListSize; | /* Length of LIST chunk |

minus 8 */

| | | |
|---|---|---|
| DWORD | ListType; | /* “fram” */ |

| | | |
|---|---|---|
| CURSORSUBCHUNK | Frames[ ]; | /* Array of cursor |

data */

} LISTFRAMECHUNK;

The cursors:

TABLE 7

| typedef struct_CursorSubchunk | |
|---|---|
| { | |
| DWORD ChunkId; | /* Subchunk ID (always |

| | |
|---|---|
| | “icon”) */ |
| DWORD Size; | /* Length of subchunk minus 8 */ |

| | |
|---|---|
| BYTE Data[ ]; | /* Cursor data, in cur format |

directly */

} CURSORSUBCHUNK;

A cursor storage component 140 can store the bitmap file representation of the modified base SVG file representation for use in displaying the particular cursor. In some embodiments, the cursor storage component 140 can overwrite an existing bitmap file representation of the particular cursor with the stored bitmap file representation of the modified base SVG file representation. In some embodiments, the cursor storage component 140 can provide the bitmap file representation of the particular cursor to an input stack of an operating system (not shown). The operating system can then utilize the bitmap representation to particular cursor to display the particular cursor on a computer display.

In some embodiments, an application or operating system is able to generate one or more cursor(s) for a plurality of computer display densities (e.g., dots per inch (DPI) and/or pixels per inch (PPI). In this manner, for a computer user using multiple display screen in extended desktop mode, the same cursor can be displayed seamlessly across the multiple display screens.

Once the bitmap file representation of the modified base SVG file representation has been stored by the cursor storage component 140, an optional cursor utilization component 150 (e.g., operating system and/or application) can utilize the bitmap file representation of the modified base SVG file representation to generate/display the particular cursor. For example, the bitmap file representation of the particular cursor can be provided to an input stack of an operating system, and, utilized the bitmap representation to particular cursor to display the particular cursor on the computer display.

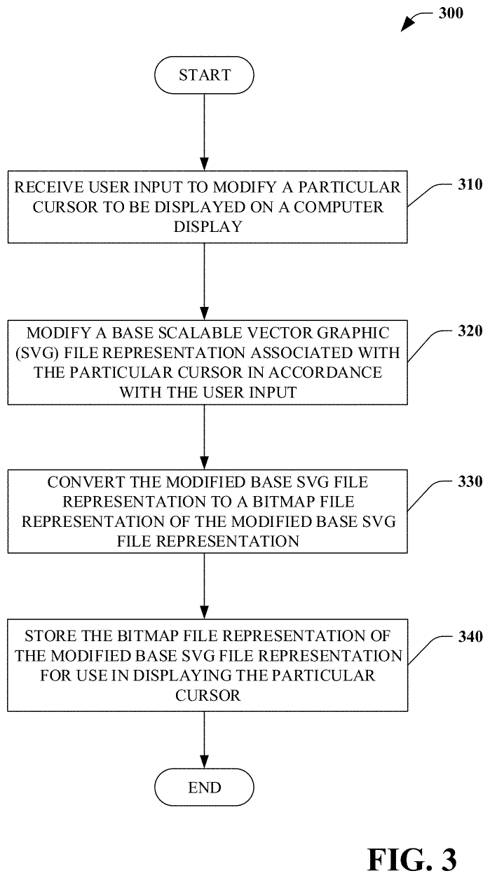

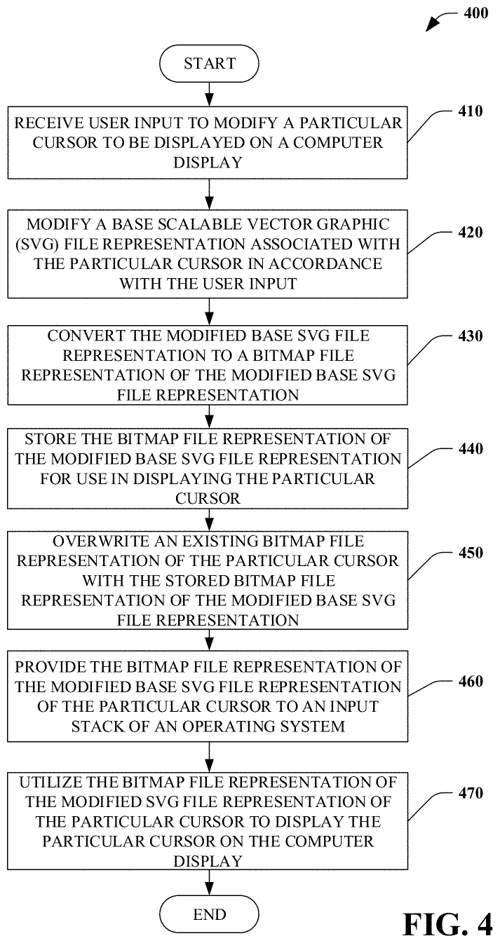

FIGS. 3 and 4 illustrate exemplary methodologies relating to automatically generating a cursor bitmap file from a scalable vector graphic file. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 3, a method of automatically generating a cursor bitmap file from a scalable vector graphic file 300 is illustrated. In some embodiments, the method 300 is performed by the system 100.

At 310, user input to modify a particular cursor to be displayed on a computer display is received. The user input can include, for example, color, and/or size information.

At 320, a base scalable vector graphic (SVG) file representation associated with the particular cursor is modified in accordance with the user input. At 330, the modified base SVG file representation is converted to a bitmap file representation of the modified base SVG file representation. At 340, the bitmap file representation of the modified base SVG file representation for using in displaying the particular cursor is stored.

Referring to FIG. 4, a method of automatically generating a cursor bitmap file from a scalable vector graphic file 400 is illustrated. In some embodiments, the method 400 is performed by the system 100.

At 410, user input to modify a particular cursor to be displayed on a computer display is received. The user input can include, for example, color, and/or size information.

At 420, a base scalable vector graphic (SVG) file representation associated with the particular cursor is modified in accordance with the user input. At 430, the modified base SVG file representation is converted to a bitmap file representation of the modified base SVG file representation. At 440, the bitmap file representation of the modified base SVG file representation for using in displaying the particular cursor is stored.

At 450, an existing bitmap file representation of the particular cursor is overwritten with the stored bitmap file representation of the modified base SVG file representation. At 460, the bitmap file representation of the modified base SVG file representation of the particular cursor is provided to an input stack of an operating system. At 470, the bitmap file representation of the modified SVG file representation of the particular cursor is utilized to display the particular cursor on the computer display.

Described herein is a system for automatically generating a cursor bitmap file for a particular cursor, comprising: a processing system comprising one or more processors and a memory having computer-executable instructions stored thereupon which, when executed by the one or more processors, cause the processing system to: receive user input to modify a particular cursor to be displayed on a computer display; modify a base scalable vector graphic (SVG) file representation associated with the particular cursor in accordance with the user input; convert the modified base SVG file representation to a bitmap file representation of the modified base SVG file representation; and store the bitmap file representation of the modified base SVG file representation for use in displaying the particular cursor.

The system can include wherein user input specifies at least one of a color, or a size of the particular cursor. The system can include wherein converting the modified base SVG file representation to the bitmap file representation of the modified base SVG file representation comprises: generate an image in a buffer in accordance with instructions specified in the modified base SVG file representation; and read pixel values associated with the generated image in the buffer to generate the bitmap file representation of the modified base SVG file representation. The system can include wherein the stored bitmap file representation of the modified base SVG file representation is utilized by an operating system to generate a system cursor.

The system can include wherein the stored bitmap file representation of the modified base SVG file representation is utilized by an application to generate an application-specific cursor. The system can include overwrite an existing bitmap file representation of the particular cursor with the stored bitmap file representation of the modified base SVG file representation. The system can include, further comprising: provide the bitmap file representation of the modified base SVG file representation of the particular cursor to an input stack of an operating system; and utilize the bitmap file representation of the modified base SVG file representation of the particular cursor to display the particular cursor on the computer display. The system can include wherein convert the modified base SVG file representation to the bitmap file representation of the modified base SVG file representation comprises generating a bitmap representation for each of a plurality of display densities.

Described herein is method for automatically generating a cursor bitmap file for a particular cursor, comprising: receiving user input to modify a particular cursor to be displayed on a computer display; modifying a base scalable vector graphic (SVG) file representation associated with the particular cursor in accordance with the user input; converting the modified base SVG file representation to a bitmap file representation of the modified base SVG file representation; and storing the bitmap file representation of the modified base SVG file representation for use in displaying the particular cursor.

The method can include wherein user input specifies at least one of a color, or a size of the particular cursor. The method can include wherein converting the modified base SVG file representation to the bitmap file representation of the modified base SVG file representation comprises: generating an image in a buffer in accordance with instructions specified in the modified base SVG file; and reading pixel values associated with the generated image in the buffer to generate the bitmap file representation of the modified base SVG file representation.

The method can include wherein the stored bitmap file representation of the modified base SVG file representation is utilized by an operating system to generate a system cursor. The method can include wherein the stored bitmap file representation of the modified base SVG file representation is utilized by an application generate an application-specific cursor. The method can include further comprising: overwriting an existing bitmap file representation of the particular cursor with the stored bitmap file representation of the modified base SVG file representation.

The method can include further comprising: providing the bitmap file representation of the modified base SVG file representation of the particular cursor to an input stack of an operating system; and utilizing the bitmap file representation of the modified base SVG file representation of the particular cursor to display the particular cursor on the computer display.

Described herein is a computer storage media storing computer-readable instructions that when executed cause a computing device to: receive user input to modify a particular cursor to be displayed on a computer display; modify a base scalable vector graphic (SVG) file representation associated with the particular cursor in accordance with the user input; convert the modified base SVG file representation to a bitmap file representation of the modified base SVG file; store the bitmap file representation of the modified base SVG file representation for use in displaying the particular cursor; overwrite an existing bitmap file representation of the particular cursor with the stored bitmap file representation of the modified base SVG file; and utilize the bitmap file representation of the modified base SVG file representation of the particular cursor to display the particular cursor on the computer display.

The computer storage media can include wherein user input specifies at least one of a color, or a size of the particular cursor. The computer storage media can include wherein converting the modified base SVG file representation to the bitmap file representation of the modified base SVG file representation comprises: generate an image in a buffer in accordance with instructions specified in the modified base SVG file; and read pixel values associated with the generated image in the buffer to generate the bitmap file representation of the modified base SVG file representation. The computer storage media can include wherein the stored bitmap file representation of the modified base SVG file representation is utilized by an operating system to generate a system cursor. The computer storage media can include wherein convert the modified base SVG file representation to the bitmap file representation of the modified base SVG file representation comprises generating a bitmap representation for each of a plurality of display densities.

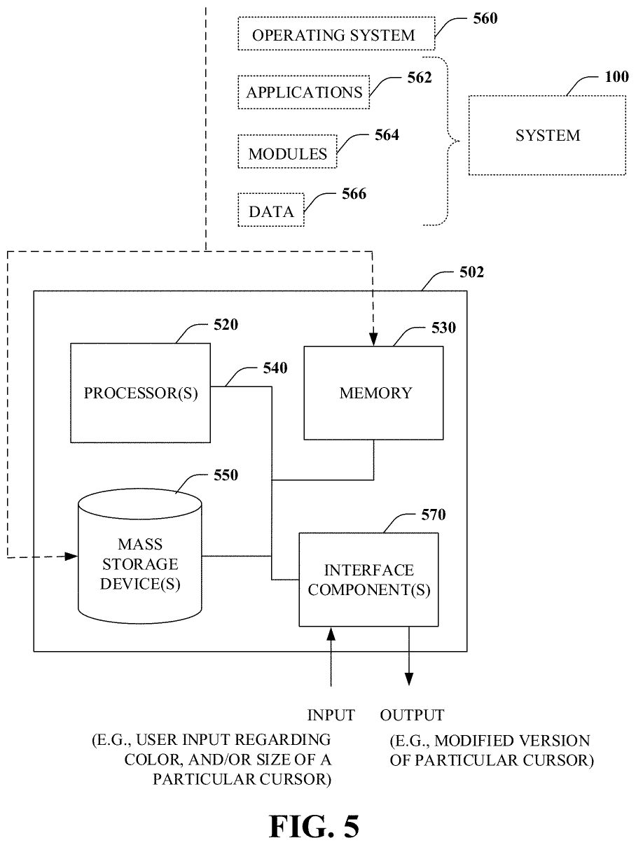

With reference to FIG. 5, illustrated is an example general-purpose processing system, computer or computing device 502 (e.g., mobile phone, desktop, laptop, tablet, watch, server, hand-held, programmable consumer or industrial electronics, set-top box, game system, compute node, etc.). For instance, the computing device 502 may be used in a system for automatically generating a cursor bitmap file from a scalable vector graphic file 100.

The computer 502 includes one or more processor(s) 520, memory 530, system bus 540, mass storage device(s) 550, and one or more interface components 570. The system bus 540 communicatively couples at least the above system constituents. However, it is to be appreciated that in its simplest form the computer 502 can include one or more processors 520 coupled to memory 530 that execute various computer executable actions, instructions, and or components stored in memory 530. The instructions may be, for instance, instructions for implementing functionality described as being carried out by one or more components discussed above or instructions for implementing one or more of the methods described above.

The processor(s) 520 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 520 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 520 can be a graphics processor.

The computer 502 can include or otherwise interact with a variety of computer-readable media to facilitate control of the computer 502 to implement one or more aspects of the claimed subject matter. The computer-readable media can be any available media that can be accessed by the computer 502 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 502. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 530 and mass storage device(s) 550 are examples of computer-readable storage media. Depending on the exact configuration and type of computing device, memory 530 may be volatile (e.g., RAM), non-volatile (e.g., ROM, flash memory, etc.) or some combination of the two. By way of example, the basic input/output system (BIOS), including basic routines to transfer information between elements within the computer 502, such as during start-up, can be stored in nonvolatile memory, while volatile memory can act as external cache memory to facilitate processing by the processor(s) 520, among other things.

Mass storage device(s) 550 includes removable/non-removable, volatile/non-volatile computer storage media for storage of large amounts of data relative to the memory 530. For example, mass storage device(s) 550 includes, but is not limited to, one or more devices such as a magnetic or optical disk drive, floppy disk drive, flash memory, solid-state drive, or memory stick.

Memory 530 and mass storage device(s) 550 can include, or have stored therein, operating system 560, one or more applications 562, one or more program modules 564, and data 566. The operating system 560 acts to control and allocate resources of the computer 502. Applications 562 include one or both of system and application software and can exploit management of resources by the operating system 560 through program modules 564 and data 566 stored in memory 530 and/or mass storage device (s) 550 to perform one or more actions. Accordingly, applications 562 can turn a general-purpose computer 502 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 562, and include one or more modules 564 and data 566 stored in memory and/or mass storage device(s) 550 whose functionality can be realized when executed by one or more processor(s) 520.

In accordance with one particular embodiment, the processor(s) 520 can correspond to a system on a chip (SOC) or like architecture including, or in other words integrating, both hardware and software on a single integrated circuit substrate. Here, the processor(s) 520 can include one or more processors as well as memory at least similar to processor(s) 520 and memory 530, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 502 also includes one or more interface components 570 that are communicatively coupled to the system bus 540 and facilitate interaction with the computer 502. By way of example, the interface component 570 can be a port (e.g., serial, parallel, PCMCIA, USB, FireWire, etc.) or an interface card (e.g., sound, video, etc.) or the like. In one example implementation, the interface component 570 can be embodied as a user input/output interface to enable a user to enter commands and information into the computer 502, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 570 can be embodied as an output peripheral interface to supply output to displays (e.g., LCD, LED, plasma, etc.), speakers, printers, and/or other computers, among other things. Still further yet, the interface component 570 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for automatically generating a cursor bitmap file for a particular cursor, comprising:
a processing system comprising one or more processors and a memory having computer-executable instructions stored thereupon which, when executed by the one or more processors, cause the processing system to:
receive user input to modify a particular cursor to be displayed on a computer display;
modify a base scalable vector graphic (SVG) file representation associated with the particular cursor in accordance with the user input;
convert the modified base SVG file representation to a bitmap file representation of the modified base SVG file representation; and
store the bitmap file representation of the modified base SVG file representation for use in displaying the particular cursor.

2. The system of claim 1, wherein user input specifies at least one of a color, or a size of the particular cursor.

3. The system of claim 1, wherein converting the modified base SVG file representation to the bitmap file representation of the modified base SVG file representation comprises:
generate an image in a buffer in accordance with instructions specified in the modified base SVG file representation; and
read pixel values associated with the generated image in the buffer to generate the bitmap file representation of the modified base SVG file representation.

4. The system of claim 1, wherein the stored bitmap file representation of the modified base SVG file representation is utilized by an operating system to generate a system cursor.

5. The system of claim 1, wherein the stored bitmap file representation of the modified base SVG file representation is utilized by an application to generate an application-specific cursor.

6. The system of claim 1, the memory having further computer-executable instructions stored thereupon which, when executed by the one or more processors, cause the processing system to:
overwrite an existing bitmap file representation of the particular cursor with the stored bitmap file representation of the modified base SVG file representation.

7. The system of claim 6, the memory having further computer-executable instructions stored thereupon which, when executed by the one or more processors, cause the processing system to:
provide the bitmap file representation of the modified base SVG file representation of the particular cursor to an input stack of an operating system; and
utilize the bitmap file representation of the modified base SVG file representation of the particular cursor to display the particular cursor on the computer display.

8. The system of claim 1, wherein convert the modified base SVG file representation to the bitmap file representation of the modified base SVG file representation comprises generating a bitmap representation for each of a plurality of display densities.

9. A method for automatically generating a cursor bitmap file for a particular cursor, comprising:
receiving user input to modify a particular cursor to be displayed on a computer display;
modifying a base scalable vector graphic (SVG) file representation associated with the particular cursor in accordance with the user input;
converting the modified base SVG file representation to a bitmap file representation of the modified base SVG file representation; and
storing the bitmap file representation of the modified base SVG file representation for use in displaying the particular cursor.

10. The method of claim 9, wherein user input specifies at least one of a color, or a size of the particular cursor.

11. The method of claim 9, wherein converting the modified base SVG file representation to the bitmap file representation of the modified base SVG file representation comprises:
generating an image in a buffer in accordance with instructions specified in the modified base SVG file; and
reading pixel values associated with the generated image in the buffer to generate the bitmap file representation of the modified base SVG file representation.

12. The method of claim 9, wherein the stored bitmap file representation of the modified base SVG file representation is utilized by an operating system to generate a system cursor.

13. The method of claim 9, wherein the stored bitmap file representation of the modified base SVG file representation is utilized by an application generate an application-specific cursor.

14. The method of claim 9, further comprising:
overwriting an existing bitmap file representation of the particular cursor with the stored bitmap file representation of the modified base SVG file representation.

15. The method of claim 14, further comprising:
providing the bitmap file representation of the modified base SVG file representation of the particular cursor to an input stack of an operating system; and
utilizing the bitmap file representation of the modified base SVG file representation of the particular cursor to display the particular cursor on the computer display.

16. A computer storage media storing computer-readable instructions that when executed cause a computing device to:
receive user input to modify a particular cursor to be displayed on a computer display;
modify a base scalable vector graphic (SVG) file representation associated with the particular cursor in accordance with the user input;
convert the modified base SVG file representation to a bitmap file representation of the modified base SVG file;
store the bitmap file representation of the modified base SVG file representation for use in displaying the particular cursor;
overwrite an existing bitmap file representation of the particular cursor with the stored bitmap file representation of the modified base SVG file; and
utilize the bitmap file representation of the modified base SVG file representation of the particular cursor to display the particular cursor on the computer display.

17. The computer storage media of claim 16, wherein user input specifies at least one of a color, or a size of the particular cursor.

18. The computer storage media of claim 16, wherein converting the modified base SVG file representation to the bitmap file representation of the modified base SVG file representation comprises:
generate an image in a buffer in accordance with instructions specified in the modified base SVG file; and
read pixel values associated with the generated image in the buffer to generate the bitmap file representation of the modified base SVG file representation.

19. The computer storage media of claim 16, wherein the stored bitmap file representation of the modified base SVG file representation is utilized by an operating system to generate a system cursor.

20. The computer storage media of claim 16, wherein convert the modified base SVG file representation to the bitmap file representation of the modified base SVG file representation comprises generating a bitmap representation for each of a plurality of display densities.
